(19) United States
(12) Patent Application Publication
(10) Pub. No.: US 2026/0299199 A1
(43) Pub. Date: Oct. 1, 2026

(54) INTEGRATED POLARIZATION SPLITTER-ROTATOR

(71) Applicant: NeoPhotonics Corporation, SAN JOSE, CA (US)

(72) Inventors: Md Borhan MIA, San Jose, CA (US); Jian WANG, San Jose, CA (US); Kenneth A. MCGREER, San Jose, CA (US)

(21) Appl. No.: 19/255,030

(22) Filed: Jun. 30, 2025

Related U.S. Application Data
(60) Provisional application No. 63/779,434, filed on Mar. 28, 2025.

(51) Int. Cl. G02B 6/126; G02B 6/122

(52) U.S. Cl. CPC G02B 6/126; G02B 6/1228

(57) ABSTRACT

In some implementations, an optical assembly may transmit light into a rotator, the rotator including: an optical cladding; a silicon nitride (SiNₓ) waveguide core surrounded by the optical cladding and having an upper layer and a lower layer, wherein the upper layer has a first upper width and a second upper width, and the first upper width decreasingly tapers to the second upper width across a length of the SiNₓ waveguide core, wherein the lower layer has a first lower width and a second lower width, and the first lower width increasingly tapers to the second lower width across the length of the SiNₓ waveguide core, and wherein the second upper width is greater than or equal to the second lower width. The optical assembly may transmit the light to a mode splitter connected to the rotator. The optical assembly may output the light via a plurality of waveguides.

### CROSS-REFERENCE TO RELATED APPLICATION

This Patent Application claims priority to Provisional Patent Application No. 63/779,434, filed on Mar. 28, 2025, and entitled “INTEGRATED POLARIZATION SPLITTER-ROTATOR.” The disclosure of the prior Application is considered part of and is incorporated by reference into this Patent Application.

### TECHNICAL FIELD

The present disclosure relates generally to an optical assembly and to an integrated polarization splitter-rotator that transmits and outputs light.

### BACKGROUND

Optical polarization splitter-rotators (PSRs) are often used in photonics applications. PSRs are passive photonic devices that are used to separate and rotate the polarization of light. For example, the PSR may separate light into two orthogonal polarization components, referred to as a transverse electric (TE) mode and a transverse magnetic (TM) mode. Additionally, the PSR may change (e.g., rotate) the polarization direction of one polarized light input, while the other polarized light input may maintain an original state. By combining the separation and rotation functions, the PSR may manipulate the polarization state of light within a single device.

### SUMMARY

In some implementations, a rotator includes an optical cladding including a top optical cladding and a bottom optical cladding; and a silicon nitride (SiNₓ) waveguide core surrounded by the optical cladding and having an upper layer and a lower layer, wherein the upper layer has a first upper width and a second upper width, and the first upper width decreasingly tapers to the second upper width across a length of the SiNₓ waveguide core, wherein the lower layer has a first lower width and a second lower width, and the first lower width increasingly tapers to the second lower width across the length of the SiNₓ waveguide core, and wherein the second upper width is greater than or equal to the second lower width.

In some implementations, a method includes transmitting light into a rotator, the rotator including: an optical cladding including a top optical cladding and a bottom optical cladding; a SiNₓ waveguide core surrounded by the optical cladding and having an upper layer and a lower layer, wherein the upper layer has a first upper width and a second upper width, and the first upper width decreasingly tapers to the second upper width across a length of the SiNₓ waveguide core, wherein the lower layer has a first lower width and a second lower width, and the first lower width increasingly tapers to the second lower width across the length of the SiNₓ waveguide core, and wherein the second upper width is greater than or equal to the second lower width; transmitting the light, from the rotator, to a mode splitter connected to the rotator; and outputting the light, from the mode splitter, via a plurality of waveguides.

In some implementations, an optical assembly includes a rotator configured to transmit light, the rotator including: an optical cladding including a top optical cladding and a bottom optical cladding, and a SiNₓ waveguide core surrounded by the optical cladding and having an upper layer and a lower layer, wherein the upper layer has a first upper width and a second upper width, and the first upper width decreasingly tapers to the second upper width across a length of the SiNₓ waveguide core, wherein the lower layer has a first lower width and a second lower width, and the first lower width increasingly tapers to the second lower width across the length of the SiNₓ waveguide core, and wherein the second upper width is greater than or equal to the second lower width; and a mode splitter configured to transmit the light, the mode splitter optically connected to the rotator, wherein the mode splitter is associated with a mode splitter segment having a first end and a second end, and wherein the mode splitter segment includes a first waveguide and a second waveguide, and wherein the first waveguide has a first width corresponding to the first end of the mode splitter segment and a second width corresponding to the second end of the mode splitter segment, the first width being greater than or equal to the second width.

### BRIEF DESCRIPTION OF THE DRAWINGS

FIG. 1 is a diagram illustrating an example of a polarization splitter-rotator (PSR).

FIG. 2 is a diagram illustrating an example of effective indices of transverse electric modes.

FIG. 3 is a diagram illustrating an example of hybrid PSRs.

FIG. 4 illustrates an example of an integrated PSR.

FIGS. 5A-5B illustrate examples of integrated PSRs.

FIGS. 6A-6B illustrate an example of an integrated PSR and an example of indices of modes at different wavelengths.

FIGS. 7A-7F illustrate an example of mode profiles associated with different slab thicknesses for an integrated PSR.

FIGS. 8A-8B illustrate an example of a mode rotation segment and an example of mode transmission profiles associated with different modes and wavelengths for an integrated PSR.

FIGS. 9A-9B illustrate an example of a splitting segment and an example of effective indices of different modes and different gaps for an integrated PSR.

FIGS. 10A-10F illustrate examples of field profiles of different modes for an integrated PSR and mode field distributions along respective mode-splitting segments of the integrated PSR.

FIGS. 11A-11B illustrate an example of a splitting segment and an example of transmission profiles of different modes along different splitting lengths for an integrated PSR.

FIGS. 12A-12B illustrate an example of a schematic of integrated PSR and an example of effective indices for an integrated PSR.

FIG. 13 is a flowchart of an example process associated with an integrated PSR.

### DETAILED DESCRIPTION

The following detailed description of example implementations refers to the accompanying drawings. The same reference numbers in different drawings may identify the same or similar elements.

Optical polarization splitter-rotators (PSRs) are often used in photonics applications. PSRs are passive photonic devices that are used to separate and rotate the polarization of light. For example, a PSR may separate light into two orthogonal polarization components, referred to as a transverse electric (TE) mode and a transverse magnetic (TM) mode. Additionally, the PSR may change (e.g., rotate) the polarization direction of one polarized light input, while the other polarized light input may maintain an original state. By combining the separation and rotation functions, the PSR may manipulate the polarization state of light within a single device.

In some examples, PSRs may utilize a silicon (Si) platform or a Si/SiN hybrid platform. In such Si/SiN examples, there may be a high birefringence introduced by the Si waveguide, which may strengthen hybridization between TM₀ and TE₁ modes. However, such PSRs are unsuitable for high-power applications due to nonlinear losses from Si's two-photon absorption.

Some implementations described herein enable an optical assembly including a rotator with optical cladding and a SiNₓ waveguide core. Additionally, the optical assembly may include a mode splitter optically connected to the rotator, the mode splitter including a mode splitter segment having a first end and a second end, and a first waveguide and a second waveguide. In some aspects, the SiNₓ waveguide core may include a slab SiNₓ waveguide and a rib SiNₓ waveguide. As a result, the design may enhance mode coupling between modes (e.g., a TE₁ mode and a TM₀ mode) in a mode rotation segment, thereby enabling efficient conversion of the TM₀ mode to the TE₁ mode while leaving the TE₀ mode unaffected. Additionally, the SiNₓ waveguide core may enable low optical nonlinearity in high-power applications, thereby reducing absorption losses. Furthermore, the relatively lower refractive index of SiNₓ may reduce scattering losses caused by sidewall roughness, thereby reducing optical losses. Additionally, the utilization of slab waveguides may improve hybridization, thereby enabling the use of SiNₓ without relying on high-refringence materials (e.g., Si).

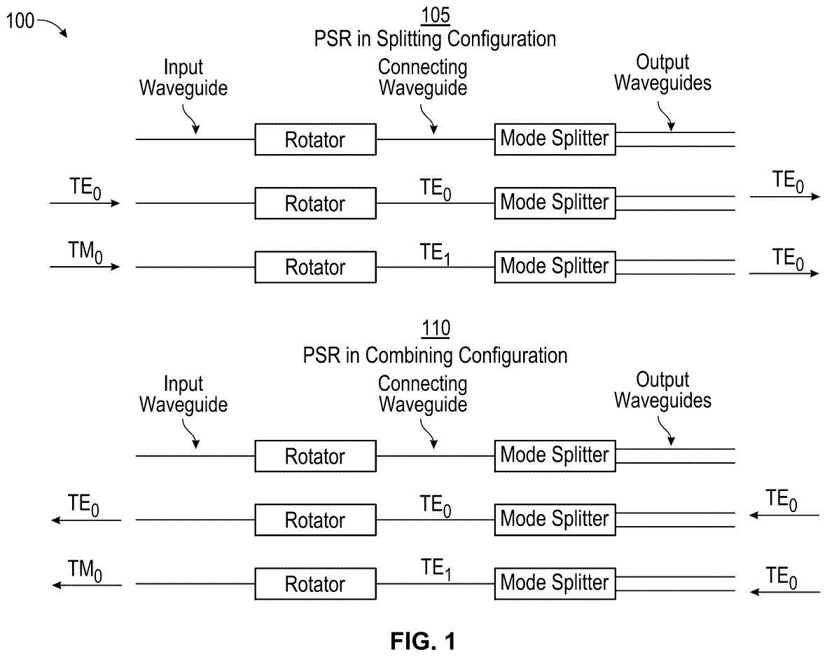

FIG. 1 is a diagram illustrating an example 100 of a PSR. In some examples, a PSR may refer to a passive photonic component that splits polarized light into two separate paths according to the polarization state of the light. The PSR may be associated with TE and/or TM polarized light. In some examples, during the operation of the PSR, a polarized light input may be changed into an orthogonal polarization state, while an additional polarized light input may maintain its original state. For example, the PSR may convert TM-polarized light to TE polarization and may retain TE-polarized light in an original state. As a result, manipulation and management of light within photonic integrated circuits (PICs) may be improved, thereby improving devices associated with polarization insensitivity and increasing efficiency of coherent optical transceivers and on-chip optical communication systems.

As shown by reference number 105, a PSR may be implemented in a splitting configuration in a silicon photonics application, and may include a rotator and a mode splitter. The rotator may be connected to the mode splitter with a connecting waveguide, which may have any length, including a length of zero (e.g., the rotator may be connected directly to the mode splitter without a connecting waveguide between the rotator and the mode splitter). In some examples, and as shown by reference number 105, light may propagate from left to right (e.g., in the direction of input waveguides towards output input waveguide), which may be referred to as a splitting direction. Additionally, or alternatively, and as shown by reference number 110, light may propagate from right to left (e.g., in the direction of output waveguide to input waveguides), which may be referred to as a combining direction. Additionally, or alternatively, the light may propagate in both directions (e.g., in a splitting direction and/or in a combining direction) and may propagate simultaneously in both directions.

In some examples, the rotator may couple light that enters the rotator from the input waveguide to the output waveguide according to the polarization state of the input light. For example, the rotator may couple TE₀ polarized light from the input to the output waveguide without changing the polarization state, where the light may exit the rotator in the TE₀ polarized state. Additionally, the rotator may couple TM₀ polarized light from the input waveguide to the output waveguide while converting the polarization state of the light to the TE₁ polarization state, where the light exits the rotator in the TE₁ polarization state.

In some examples, the mode splitter may couple light that enters the mode splitter from the input waveguide to one of the plurality of waveguides according to the polarization of the input light. For example, the mode splitter may couple TE₀ polarized light from the input waveguide to one of the plurality of waveguides (e.g., a first waveguide) without changing the polarization state of the light, where the light exits the mode splitter in the TE₀ polarized state. Additionally, or alternatively, the mode splitter may couple TE₁ polarized light from the input waveguide to one of the plurality of output waveguides (e.g., a second waveguide) while converting the polarization state of the light to a TE₀ polarized state, where the light exits the mode splitter in the TE₀ polarized state.

In some examples, silicon photonics may be associated with a relatively high index of refraction, which may enable relatively higher-order TE modes (e.g., a TE₁ mode) and may facilitate hybridization and coupling between the TE₁ mode and additional TM (e.g., TM₀) modes. As a result, silicon photonics may enable rotation of the TM₀ mode to the TE₁ mode within Si waveguides.

As indicated above, FIG. 1 is provided as an example. Other examples may differ from what is described with regard to FIG. 1.

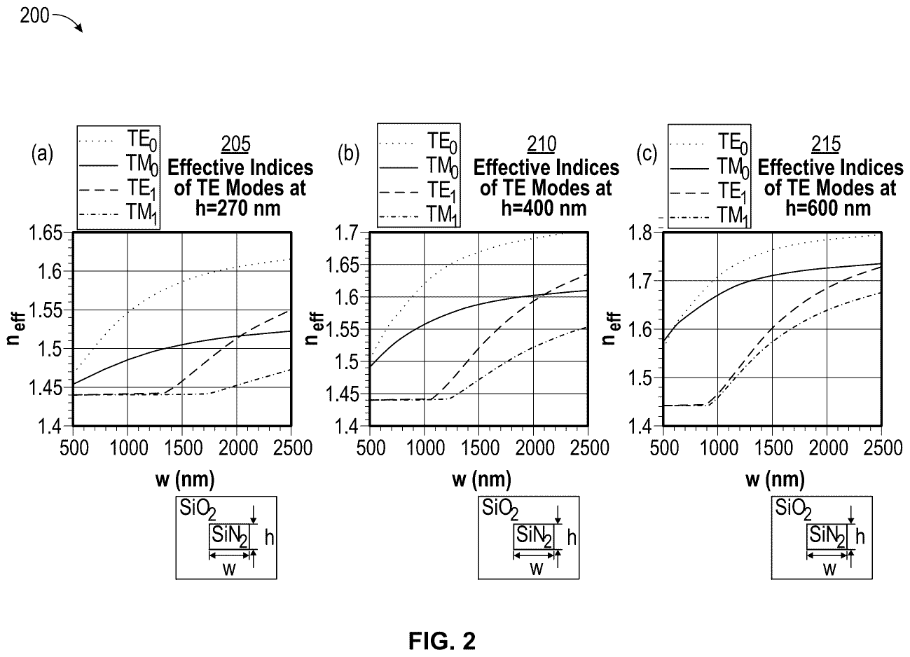

FIG. 2 is a diagram illustrating an example 200 of effective index variation of the zero (e.g., fundamental) and first order TE and TM modes as waveguide lateral width (w) is varied for certain discrete erect heights (h) of the waveguide. For example, and as shown in FIG. 2 materials having a relatively lower refractive index (e.g., silicon nitride (SiNₓ) waveguides) may utilize broader waveguides to achieve similar hybridization and coupling due to the minimal birefringence between the TE₁ mode and TM₀ mode in SiNₓ waveguides. For example, reference numbers 205, 210, and 215 illustrate effective indices of different modes (e.g., TE₀, TM₀, TE₁, and TM₁) in SiNₓ waveguides of heights 270 nanometers (nm), 400 nm, and 600 nm, respectively. The relatively weak (e.g., minimal) birefringence may lead to utilization of significant perturbation (e.g., an indicator of relative coupling rate and/or degree of resonance between adjacent modes, or a modal interaction) to increase the associated mode hybridization and coupling, which may result in longer mode conversions lengths that may be impractical for commercial PICs.

However, in some examples, passive photonic components (e.g., PSRs) may benefit from utilizing SiNₓ waveguides with silicon dioxide (e.g., SiO₂) claddings due to SiNₓ enabling increased performance relative to Si waveguides. As a result, utilization of SiNₓ may result in a decreased refraction index, which may reduce waveguide losses due to scattering with sidewall roughness, thereby increasing tolerance to variations in waveguide dimensions. Accordingly, SiNₓ PSRs may increase performance in PIC.

As indicated above, FIG. 2 is provided as an example. Other examples may differ from what is described with regard to FIG. 2.

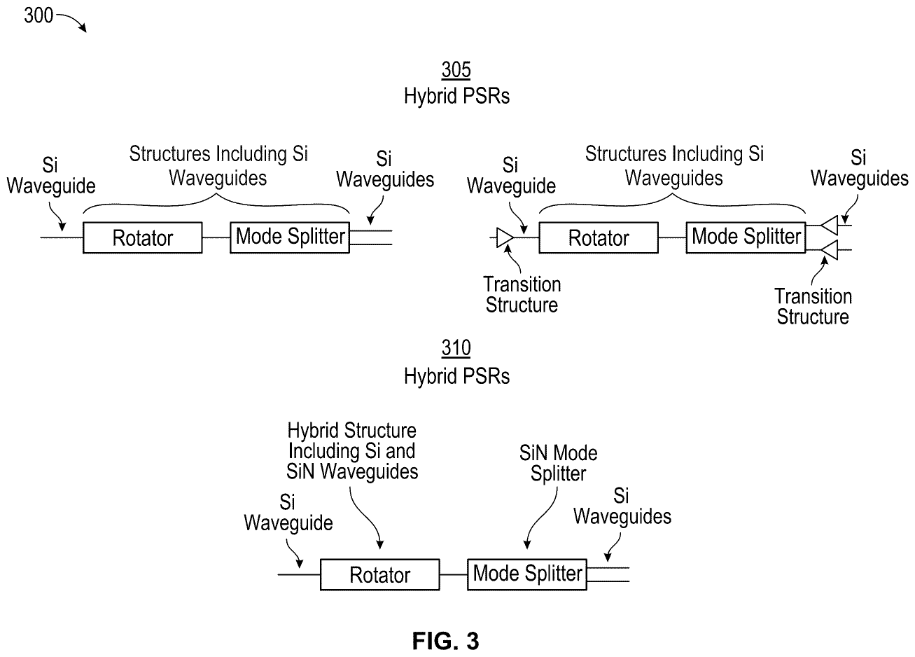

FIG. 3 is a diagram illustrating an example 300 of hybrid PSRs. As shown in FIG. 3, and by reference number 305, in some examples, a hybrid PSR with an SiNₓ to Si transition segment may facilitate mode rotation and splitting within Si waveguides before transitioning back to the SiNₓ waveguide. However, such a design may introduce additional losses (e.g., in the TM mode) due to the transmission (e.g., SiNₓ to Si and Si to SiNₓ). Additionally, such a design may result in significant two-photon absorption (TPA) losses in the Si waveguide due to its relatively high nonlinearity at relatively high power levels. As shown by reference number 310, a hybrid PSR design may include Si waveguides beneath SiNₓ waveguides, which may improve perturbation between TE₁ and TM₀ modes, thereby enabling improved mode rotation within SiNₓ waveguides. However, such a design may result in increased design complexity and may result in increased light leakage into the Si waveguide, which may cause nonlinear absorption and limit the utilization of high-power applications.

In some examples, PSRs may be utilized in an Si platform and/or an Si/SiN hybrid platform due to high birefringence introduced by an Si waveguide. Such a PSR design may increase or strengthen hybridization between TM₀ and TE₁ modes. However, such PSR designs may be unsuitable for high-power applications due to nonlinear losses from silicon's two-photon absorption. Additionally, or alternatively, SiNₓ may exhibit low birefringence between TE₀ and TM₀ modes, and there may be relatively insufficient or trivial hybridization between TE₀ and TM₀ modes, leading to challenges in PSR designs that utilize only SiNₓ. However, SiNₓ may enable improved performance for high-power applications, where SiNₓ may enable reduced scattering losses and material absorption due to SiNₓ's lower refractive index, which may minimize scattering losses from sidewall roughness and relatively low nonlinearity (e.g., at relatively high power levels).

As indicated above, FIG. 3 is provided as an example. Other examples may differ from what is described with regard to FIG. 3.

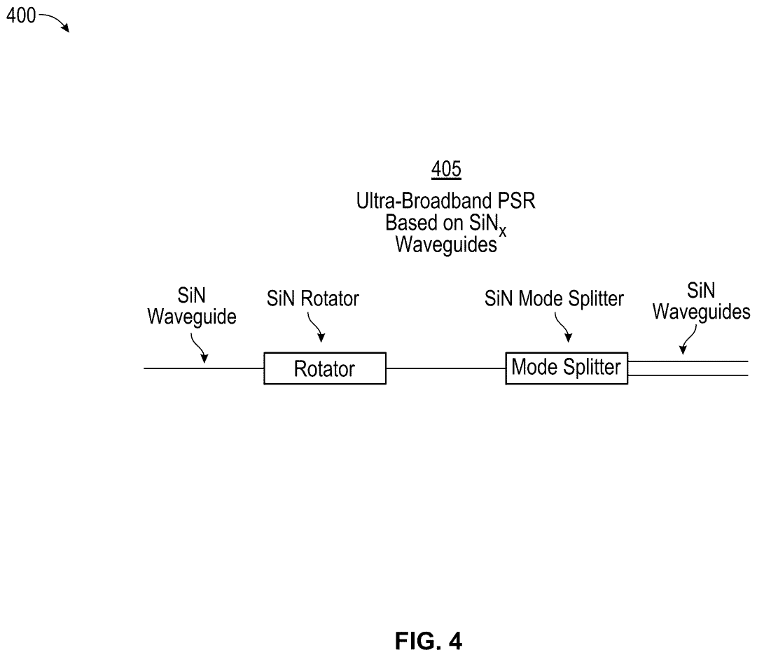

FIG. 4 illustrates an example 400 of an integrated PSR. As shown by reference number 405, for example, the integrated PSR may be an ultra-broadband PSR based on SiNₓ waveguides, which may be capable of operating across O-, C-, and/or L-bands. In some implementations, the SiN rotator may include SiN waveguides with parameters that may enable operation associated with wavelengths of 1310 nm, 1550 nm, and/or 1580 nm, among other examples. Additionally, the SiN mode splitter may include SiN waveguides. In some implementations, the PSR may include a rotator that includes rib and slab SiNₓ waveguides and may include a mode splitter that includes channel SiNₓ waveguides. Additionally, the rotator may include a rotation segment including an SiNₓ rib waveguide segment (e.g., at the input of the rotation segment) that may taper (e.g., gradually) into an SiNₓ waveguide segment at the output end of the rotator. For example, the slab region may have a relatively large width at one end and may taper (e.g., gradually) to a nearly-zero width, where the rib waveguide may be converted to an SiNₓ channel waveguide at the output end of the rotator. Additionally, or alternatively, the rotator may be designed to receive light from a channel SiNₓ waveguide by including a transition from an SiNₓ channel waveguide at the input end of the rotator to an SiNₓ rib waveguide at the input end of the rotating segment. Additionally, or alternatively, the rotator may be further connected to a mode splitter according to channel SiNₓ waveguides to include a PSR that may include SiNₓ waveguide segments.

In some implementations, an integrated PSR may utilize only SiNₓ waveguides. Additionally, or alternatively, the integrated PSR may be designed to operate across the O-, C-, and/or L-bands. As a result, the integrated PSR may include slab SiNₓ waveguides to improve mode coupling between TE₁ and TM₀ modes in a mode rotation segment, in contrast to SiNₓ-based PSRs that may be associated with relatively low birefringence and relatively minimal mode hybridization. Accordingly, the integrated PSR may enable efficient conversion of the TM₀ mode to the TE₁ mode, which may enable polarization rotation while leaving the TE₀ mode unaffected. Additionally, the utilization of slab waveguides may improve hybridization (e.g., relative to SiNₓ PSR) without utilizing materials (e.g., Si) associated with a relatively high refractive index (e.g., associated with relatively high birefringence).

Additionally, in some implementations, the integrated PSR may utilize adiabatic mode splitting that may occur after the rotation segment. In some implementations, the adiabatically coupled waveguides may separate the TE₁ and TE₀ modes, which may result in two physically-separate TE₀ modes at the output ports. Additionally, the low optical nonlinearity associated with SiNₓ may result in increased performance (e.g., minimization of absorption losses) associated with relatively high-power applications. Additionally, a relatively lower refractive index associated with SiNₓ may also reduce scattering losses caused by sidewall roughness, thereby increasing performance with relatively low optical losses. As a result, the integrated PSR design may improve efficiency and robustness across a plurality of frequencies, while enabling relatively compact and scalable optical communication applications.

As indicated above, FIG. 4 is provided as an example. Other examples may differ from what is described with regard to FIG. 4.

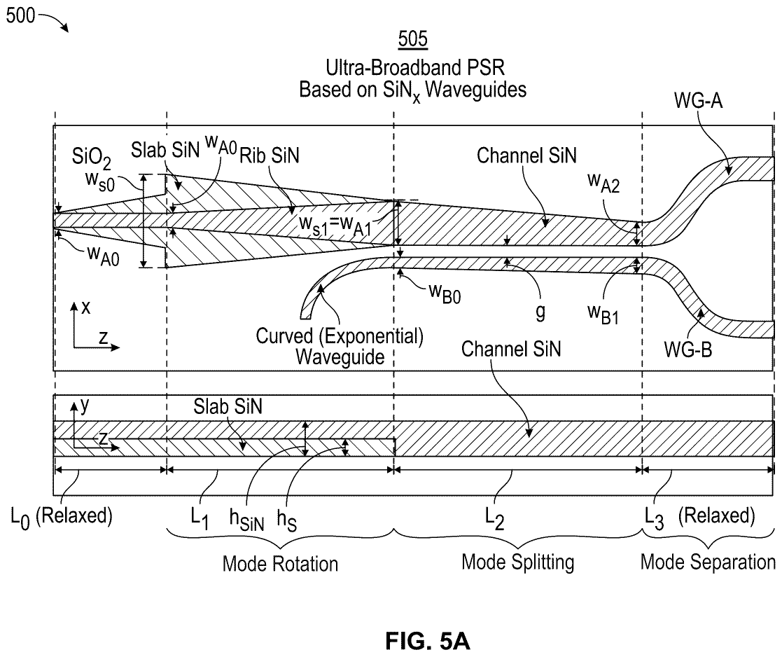

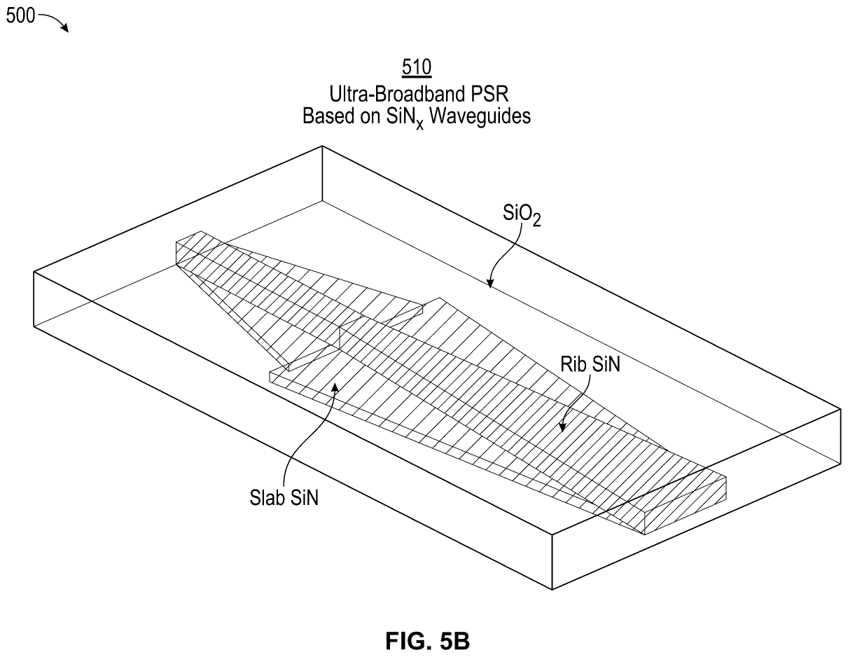

FIGS. 5A-5B illustrate examples 500 of integrated PSRs. As shown in FIG. 5A, and by reference number 505, a schematic view of a PSR is illustrated in an x-z plane and in a y-z plane. In some implementations, the PSR may utilize rib SiNₓ waveguides and/or slab SiNₓ waveguides (e.g., with SiO₂ cladding) and may be structured into multiple segments: a mode rotation segment, a mode splitting segment, and/or a mode separation segment. Additionally, the rib and slab SiNₓ heights are designated as h_{SiN} and h_{S}, respectively. In some implementations, SiO2 may be utilized as both the top and bottom cladding, which may reduce scattering and confine the optical modes within the SiNₓ waveguides, thereby reducing optical losses. The PSR may include an input segment of length L₀, a rotation segment L₁, a splitting segment L₂, and a separation segment L₃, and L₀, and/or L₃ may be a relaxed length, and L₂ and L₃ may be optimized for reducing transmission loss. For example, L₁ may be approximately 100 micrometers (μm) to 1 mm and L2 may be approximately 100 μm to 500 μm. These lengths may vary dependent on channel, rib, or slab waveguide widths or heights and/or gaps in the mode splitter segment, where the initial width of the SiNₓ waveguide may be w_{A0}. Additionally, the slab waveguide may be tapered from w_{A0} to <w_{S0} as light enters the PSR, thereby reducing transition losses.

In some implementations, the mode rotation segment (e.g., with length L₁) may be tapered for the width of the rib SiNₓ from w_{A0} to w_{A1}, while the slab waveguide may taper from w_{S0} to w_{S1}=w_{A1}. As a result, the tapering may result in increased birefringence and perturbation between the TM₀ and TE₁ modes, thereby enabling the conversion of the TM₀ mode into the TE₁ mode. The TE₀ mode, which may be associated with a large index contrast relative to other modes, may remain unaffected and may continue to propagate without coupling. In the mode splitting segment, a second waveguide, (e.g., Waveguide-B (WG-B)), may include a curved, slanted design to enable smooth mode transitions with relatively minimal scattering losses. In some implementations, mode conversion may occur at the mode splitting segment. A first waveguide (e.g., Waveguide A (WG-A)) may be tapered from w_{A1} to w_{A2}, while WG-B may be tapered from w_{B0} to w_{B1}. Such tapering may increase coupling efficiency between a TE_{1A} mode in WG-A and a TE_{0B} mode in WG-B. The mode transition from TE_{1A} to TE_{0B} may occur along a length L₂. Additionally, the TE₀ mode in WG-A may remain uncoupled due to a large index contrast passing through the WG-A. The final segment (e.g., a mode separation segment) may occur over the length L₃, where two S-bends may be utilized to separate the TE₀ modes in WG-A and WG-B. At this stage, the TE₀ mode may continue as TE_{0A} in WG-A, while the TM₀→TE_{1A}→TE_{0B} transition is completed in WG-B, thereby achieving a desired polarization splitting and rotation.

As shown in FIG. 5B, and by reference number 510, a three-dimensional (3D) view of the mode rotation segment is illustrated. In some implementations the rib SiNₓ and slab SiNₓ waveguides may be primary waveguides and the SiO₂ may serve as cladding. In some implementations, the mode rotation segment may convert the TM₀ mode to the TE₁ mode while the TE₀ mode may be unaffected (e.g., may be unassociated with coupling and/or conversion). Accordingly, such a design may include geometrical parameters of cross sections associated with various SiNₓ waveguides and may include lengths of waveguide sections that are associated with improved optical performance.

As indicated above, FIGS. 5A-5B are provided as an example. Other examples may differ from what is described with regard to FIGS. 5A-5B.

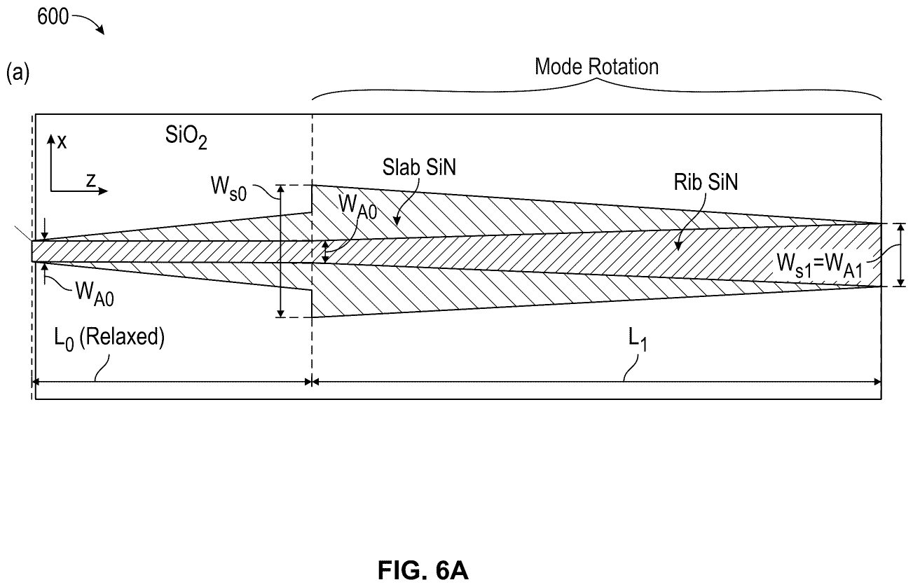

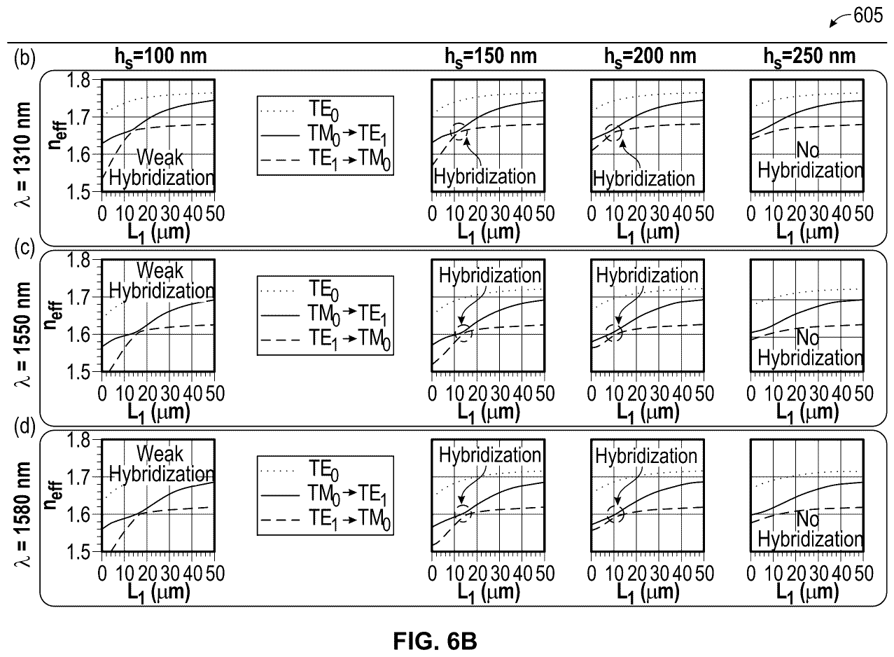

FIGS. 6A-6B illustrate an example 600 of an integrated PSR and an example 605 of indices of modes at different wavelengths. As shown in FIG. 6A, a schematic of a mode rotation segment is illustrated. For example, the mode rotation segment may include rib and slab SiNₓ waveguides and SiO₂ as top and bottom claddings. In some implementations, geometrical parameters associated with the waveguide cross sections may include h_{SiN}=400 nm, w_{A0}=1 μm, w_{S0}=4 μm, w_{A1}=2 μm, and w_{S1}=2 μm. In some implementations, the SiNₓ slab thickness (e.g., h_{S}) may vary from approximately 100 nm to approximately 300 nm.

As shown in FIG. 6B, and by reference number 605, effective indices of (e.g., n_{eff}) of TE₀, TM₀→TE₁, and/or TE₁→TM₀ modes may be associated with wavelengths of 1310 nm, 1550 nm, and 1580 nm. For example, dashed circles may indicate hybridization regions. As shown in FIG. 6B, four different slab thicknesses are illustrated (e.g., h_{S}=100, 150, 200, and 250 nm), and geometric parameters may be associated with h_{SiN}=400 nm, w_{A0}=1000 nm, w_{S0}=6000 nm, w_{A1}=4000 nm, and w_{S1}=4000 nm. In some implementations, the geometrical parameters associated with the waveguide cross sections may include h_{SiN} =400 nm, w_{A0} =1μm, w_{S0} =4μm, w_{A1} =2μm, and w_{S1} =2μm. The SiNₓ slab thickness (e.g., h_{S}) may also have a value within a range from approximately 100 nm to approximately (h_{SiN}-100 nm). In some implementations, the length of the mode rotation segment may be equal to L₁, as described with respect to FIG. 6A.

In some implementations, at a wavelength of 1310 nm, and where h_{S}=100 nm, significant hybridization perturbation may be absent between TM₀ and TE₁ modes. Additionally, as a slab thickness increases to 150 nm and 200 nm, perturbation between TM₀ and TE₁ may increase. The dashed circles indicate hybridization regions where coupling may be strongest. The perturbation Δn values (e.g., an index difference between modes) for h_{S}=150 nm and 200 nm at 1310 nm are 0.005 and 0.0073, respectively, indicating increased coupling as slab thickness increases.

In some implementations, at a wavelength of 1550 nm, hybridization perturbation between TM₀ and TE₁ modes may be stronger relative to at 1310 nm, as illustrated by dashed circles. As a result, a coupling coefficient may increase at relatively higher wavelengths. For example, at h_{S}=150 nm and h_{S}=200 nm, the perturbation Δn values vary from 0.006 and 0.008, which may be relatively higher than the 1310 nm case, which may result increased strong hybridization at the longer wavelength.

In some implementations, at a wavelength of 1580 nm, the coupling between TM₀ and TE₁ may be stronger relative to the wavelengths of 1310 nm and 1550 nm. The dashed circles may indicate hybridization regions. The perturbation Δn values for h_{S}=150 nm and h_{S} =200 nm at 1580 nm are 0.0061 and 0.0082, indicating that the relatively greater slab thickness (e.g., h_{S} =200 nm) may result in increased efficiency associated with mode coupling at longer wavelengths.

In some implementations, hybridization perturbation between TM₀ and TE₁ modes may increase with wavelength due to an enhanced coupling coefficient at relatively longer wavelengths, thereby increasing efficiency associated with mode conversion. In some implementations, relatively thicker slab waveguides (e.g., h_{S}=150 nm and h_{S}=200 nm) may result in relatively stronger mode coupling, thereby resulting in increased efficiency associated with conversion of TM₀ to TE₁. In some implementations, at h_{S}≥250 nm, coupling may be absent, and both TM₀ and TE₁ modes may pass through the rotation segment without interacting, which may result in relatively-highly confined modes. Additionally, or alternatively, the TE₀ mode may be associated with a significant index contrast associated with other modes, thereby preventing the TE₀ modes from undergoing coupling or conversion. As a result, the TE₀ mode may remain intact throughout the PSR and may follow the TE₀ path as indicated in FIG. 6B. The mode conversion (e.g., TM₀→TE₁) length may be proportional to wavelength and inversely proportional to perturbation Δn. Accordingly, at relatively longer wavelengths, where Δn increase is relatively greater than wavelength increase, the associated mode conversion length may be shorter, thereby enabling increased efficiency across a wide spectral range.

As indicated above, FIGS. 6A-6B are provided as an example. Other examples may differ from what is described with regard to FIGS. 6A-6B.

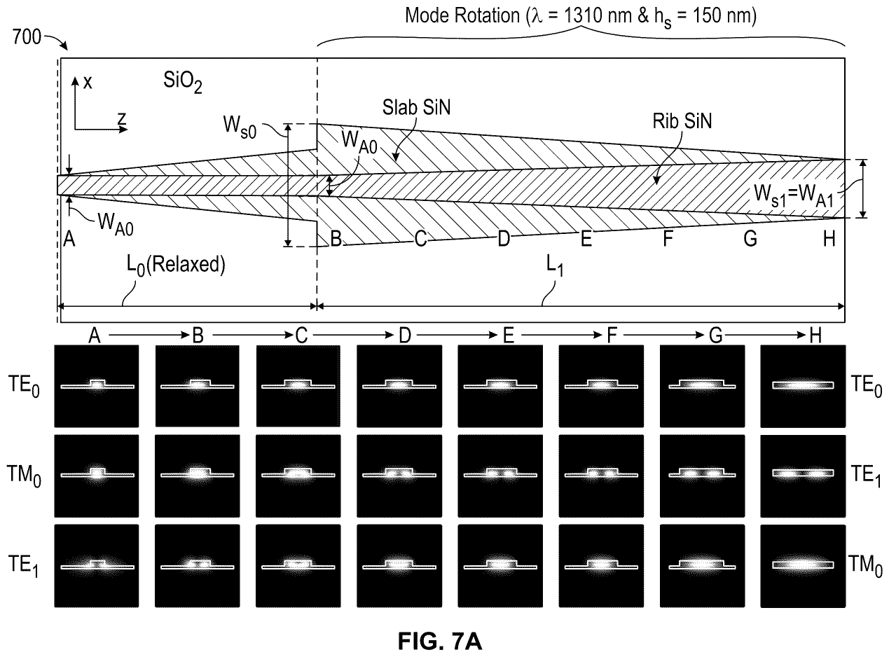

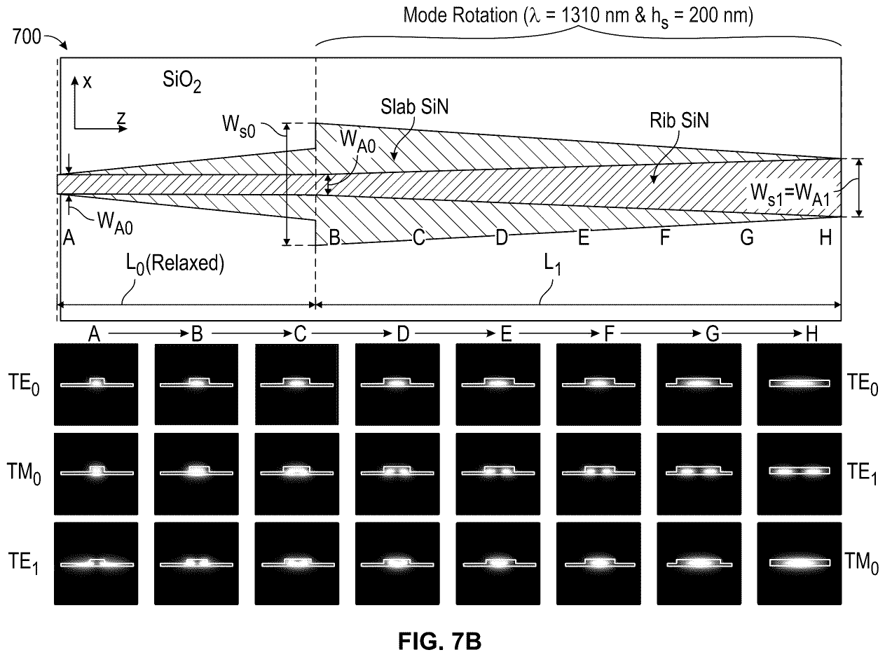

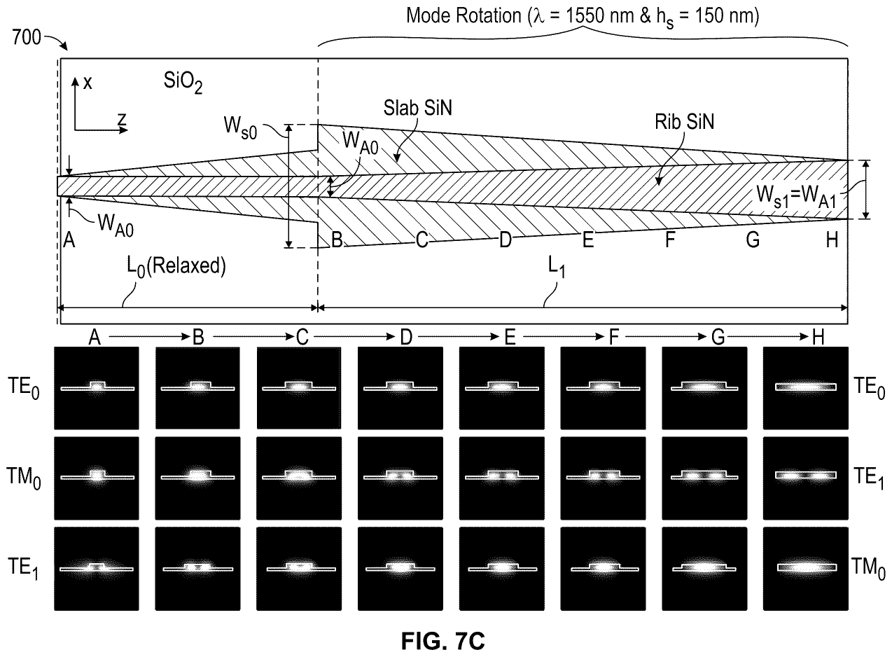

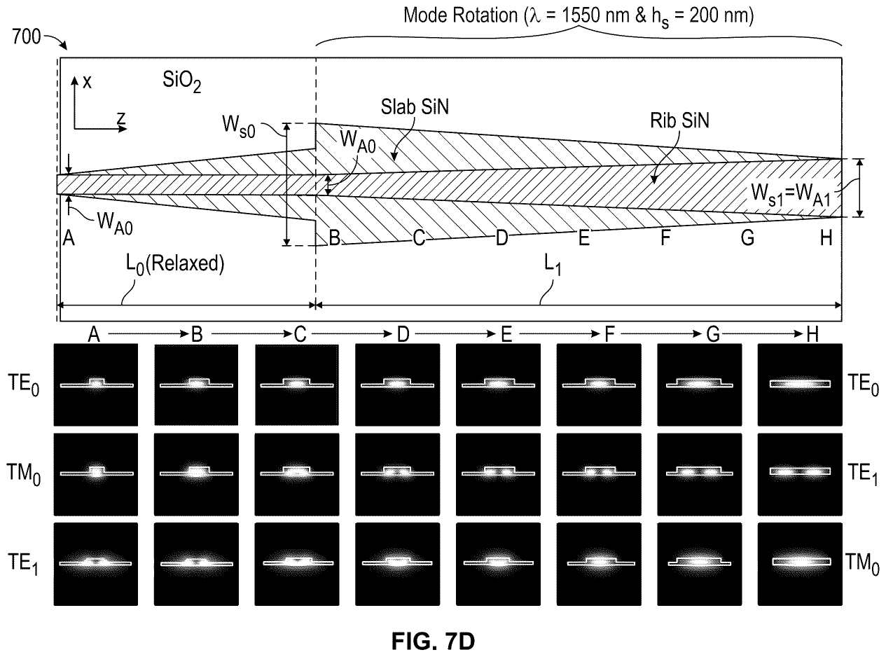

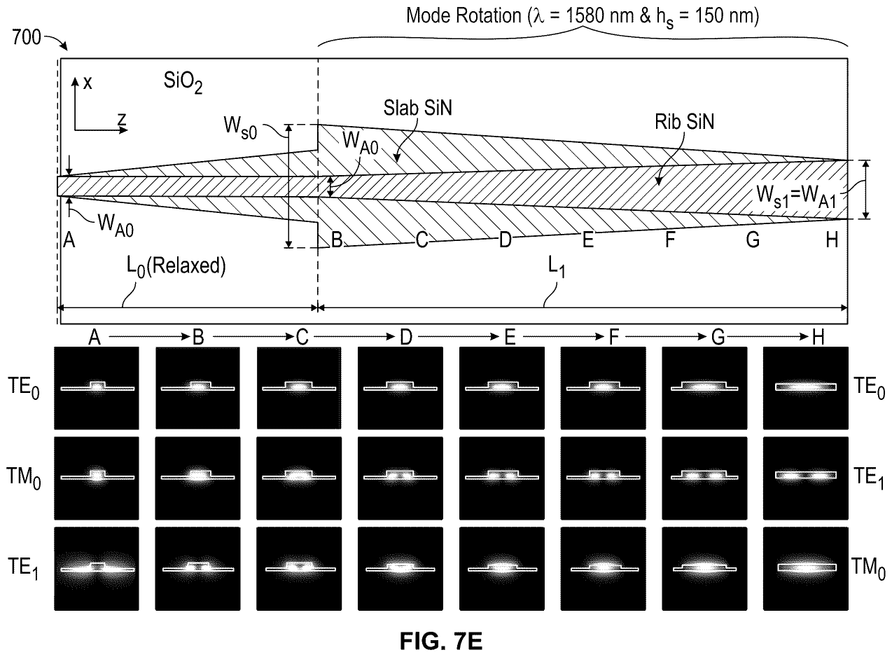

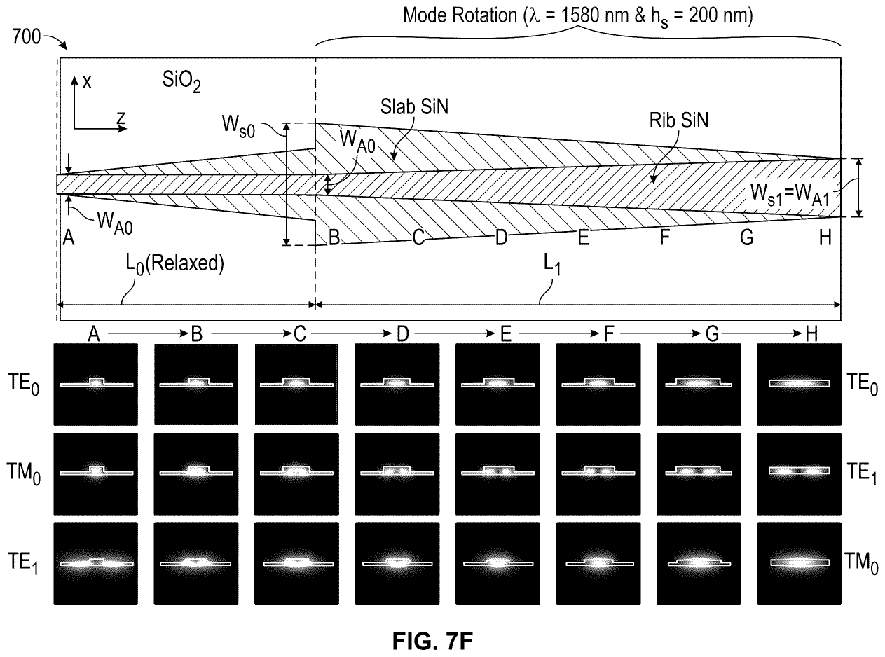

FIGS. 7A-7F illustrate an example 700 of mode profiles associated with different slab thicknesses for an integrated PSR. As shown in FIG. 7A, the mode profiles (e.g., associated with an hₛ=150 nm) may depict behavior of a TM₀ and a TE₁ mode at a wavelength of 1310 nm, where locations A through H denote the locations of each respective mode. In some implementations, the TE₀ mode may remain unaffected, retaining a path throughout the rotation. Mode coupling may occur where TM₀ converts to TE₁, as indicated by a relatively strong field overlap. For example, such coupling between modes may occur at locations C and D, where hybridization occurs, which may lead to increased efficiency associated with mode rotation. As shown in FIG. 7B, where the slab thickness increases to 200 nm (e.g., hₛ=200 nm), the coupling between TM₀ and TE₁ may increase due to a larger index difference (e.g., Δn). The increased hybridization strength may lead to increased efficiency associated with mode conversion efficiency and to conversions observed at the same locations as in FIG. 7A.

As shown in FIG. 7C, at a higher wavelength of 1550 nm and h_{S}=150 nm, the coupling between TM₀ and TE₁ may be associated with increased strength levels, and hybridization zones may be more evident due to increased coupling. Strong field interaction is depicted at locations C and D, indicating increased efficiency associated with mode rotation. As shown in FIG. 7D, at a wavelength of 1550 nm and h_{S}=200 nm, the hybridization between modes may be enhanced, thereby increasing coupling strength. As a result, there may be increased efficiency associated with TM₀ to TE₁ conversion, thereby enabling a reduced mode conversion length. The TE₀ mode may continue to propagate without interference, thereby enabling relatively minimal losses.

As shown in FIGS. 7E-7F, at a higher wavelength of 1580 nm (e.g., an L-band) and slab thicknesses of h_{S}=150 nm and h_{S}=200 nm, respectively, there may be increased hybridization between the TM₀ and TE₁ modes relative to shorter wavelengths, due to a relatively larger index contrast in hybridization regions. As shown in FIGS. 7E and 7F, the field profiles depict clear coupling between TM₀ and TE₁ modes, with efficient conversion depicted at locations C and D with h_{S}=150 nm and h_{S}=200 nm, respectively. Additionally, in some implementations, the TE₀ mode may pass without any interference and/or coupling due to a relatively large index contrast.

As a result, the field profiles of FIGS. 7A-7F depict different modal interactions optimized across varying wavelengths and/or slab thicknesses. For example, a hybridization between TM₀ and TE₁ modes may be relatively strongest at longer wavelengths (e.g., 1550 nm and 1580 nm) and with relatively larger slab thicknesses (e.g., h_{S}=200 nm), thereby increasing efficiency associated with mode conversion. Additionally, the TE₀ mode may remain unaffected by the rotation segment due to the relatively large index contrast.

As indicated above, FIGS. 7A-7F are provided as an example. Other examples may differ from what is described with regard to FIGS. 7A-7F.

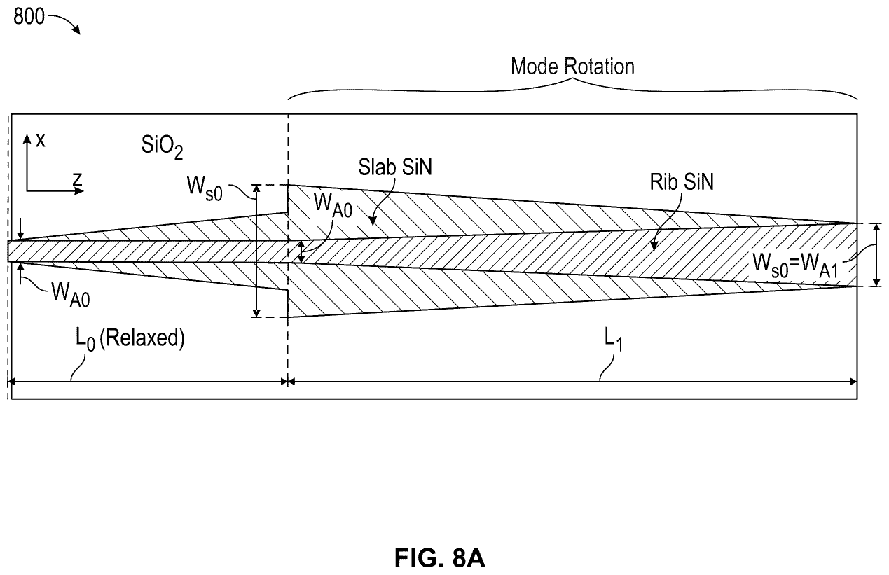

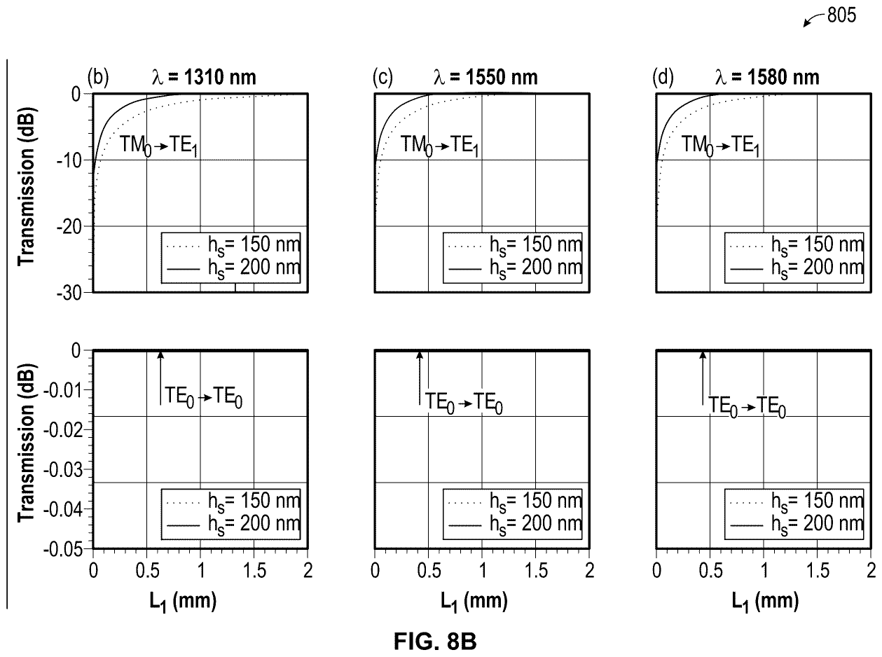

FIGS. 8A-8B illustrate an example 800 of a mode rotation segment and an example 805 of mode transmission profiles associated with different modes and wavelengths for an integrated PSR. As shown in FIG. 8A, a mode rotation segment is depicted in association with the transmission profiles of FIG. 8B. As shown in FIG. 8B, and by reference number 805, transmission profiles are depicted for profiles for the TM₀ and TE₁ modes along the length L₁ of the PSR for wavelengths of 1310 nm, 1550 nm, and 1580 nm and for slab thicknesses of 150 nm and 200 nm.

In some implementations, at a wavelength of 1310 nm, the TM₀ mode shows a gradual conversion to TE₁ as it propagates along L₁. The transmission profile depicts a relatively strong conversion from the TM₀ mode to the TE₁ mode, with the slab thickness affecting the conversion efficiency. For example, with a relatively thicker slab of h_{S}=200 nm, the conversion may occur over a shorter distance, indicating increased efficiency associated with the mode conversion. Additionally, the TE₀ mode may remain unaffected during the mode rotation process, and may propagate without significant changes or losses. Because the TE₀ mode models are essentially lossless, the corresponding charts on the lower row of example 805 illustrate traces that are flush to the top of the chart (e.g., representing approximately 0 dB across the length, L₁).

In some implementations, at a wavelength of 1550 nm, there may be an increased strength associated with the conversion efficiency from TM₀ to TE₁, and for the h_{S}=200 nm slab thickness. For example, the coupling between these modes may be more efficient at the 1550 nm wavelength relative to the coupling at 1310 nm. Additionally, as the h_{S} value increases, the mode conversion length may shorten, thereby resulting in the conversion happening over a relatively shorter distance. Additionally, and similar to the 1310 nm wavelength scenario, the TE₀ mode may remain unaffected during the mode rotation process, and may maintain its path without undergoing conversion or coupling.

In some implementations, at a wavelength of 1580 nm, an efficiency associated with the mode conversion may be further increased relative to the mode conversion efficiency associated with wavelengths of 1310 nm and/or 1550 nm. For example, the relatively larger wavelength may increase the coupling strength between TM₀ and TE₁, and with h_{S}=200 nm slab thickness, the conversion length may be further reduced. For example, the transmission profiles indicate that the TM₀ mode may convert to TE1 in a relatively short distance, illustrating the increased efficiency of the design at the relatively longer wavelength of 1580 nm. Additionally, and similar to the 1310 nm wavelength and 1550 nm wavelength scenarios, the TE₀ mode may remain unaffected during the mode rotation process, and may maintain its path without undergoing conversion or coupling.

In some implementations, as the slab thickness (e.g., h_{S}) increases from 150 nm to 200 nm, the mode conversion length may decrease, thereby indicating an h_{S} associated with increased efficiency in mode coupling and conversion. Additionally, at relatively longer wavelengths (e.g., 1550 nm and 1580 nm), the coupling between TM₀ and TE₁ may be stronger, enabling increased efficiency associated with conversion over relatively shorter distances. Across such wavelengths and slab thicknesses, the TE₀ mode may remain unaffected by the mode rotation segment due to the relatively large index contrast, thereby illustrating that the design may isolate the TE₀ mode from the mode conversion dynamics associated with the TM₀ mode.

In some implementations, the parameters for waveguide cross sections depicted in FIGS. 8A-8B may be associated with a length of the rotation segment that is sufficiently long to enable improved performance in the O-band, and accordingly, may provide improved performance in the C-band and the L-band. As a result, such parameters may indicate a rotator that includes SiN waveguides and is associated with improved broadband performance.

As indicated above, FIGS. 8A-8B are provided as an example. Other examples may differ from what is described with regard to FIGS. 8A-8B.

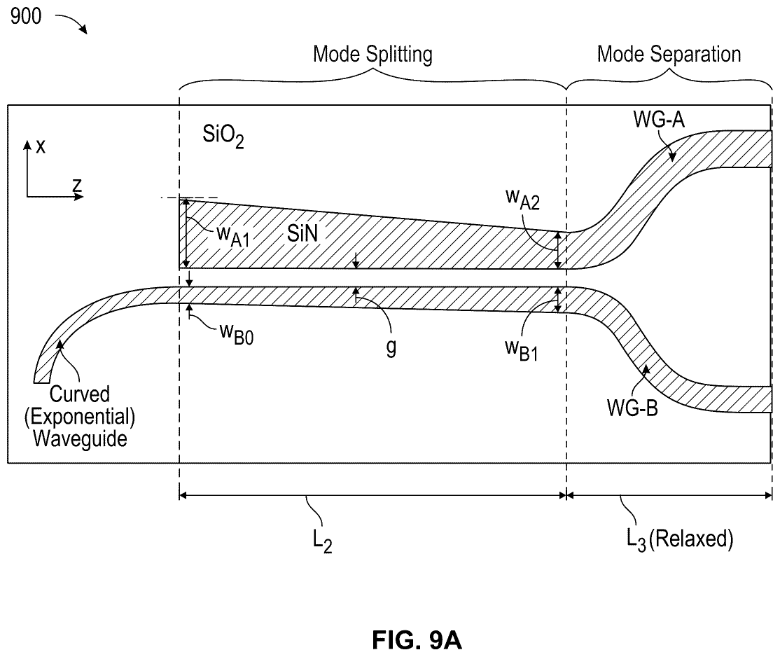

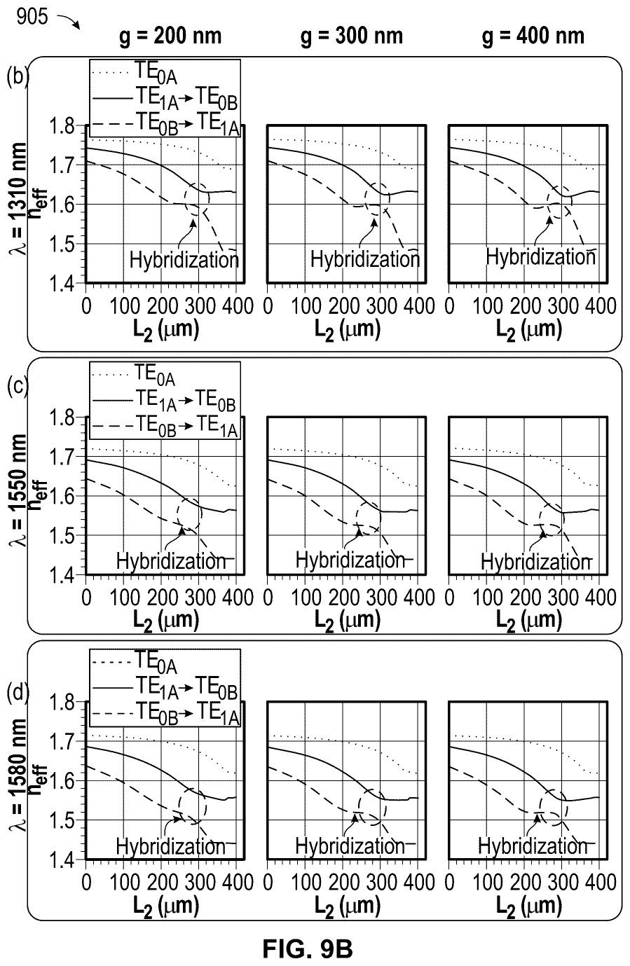

FIGS. 9A-9B illustrate an example 900 of a splitting segment and an example 905 of effective indices of different modes and different gaps for an integrated PSR. As shown in FIG. 9A and by reference number 900, a splitting segment may include a WG-A and a WG-B. In some implementations, WG-A may be associated with a waveguide after a rotation associated with a TM₀ to TE_{1A} mode conversion occurs. The couple segment may facilitates the conversion of the TE_{1A} mode in WG-A to the TE_{0B} mode in WG-B. The curved (e.g., exponential) waveguide may be used to enable smooth conversion and reduce loss. Additionally, a TE_{0A} mode may remain unaffected in WG-A.

As shown in FIG. 9B, and by reference number 905, effective indices of different modes (e.g., TE_{0A}, TE_{1A}→TE_{0B}, and TE_{0B}→TE_{1A}) are depicted along the splitting length L₂ for different wavelengths (e.g. 1310 nm, 1550 nm, and 1580 nm) and gap sizes between WG-A and WG-B. For example, dashed circles depict hybridization between TE_{1A} and TE_{0B} modes, and example 905 further depicts parameters of h_{SiN}=400 nm, w_{A1}=4000 nm, w_{A2}=1000 nm, w_{B0}=300 nm, and w_{B1}=700 nm.

In some implementations, at a wavelength of 1310 nm, the mode hybridization between TE_{1A} and TE_{0B} may be weaker relative to longer wavelengths, but mode hybridization may still be present. The hybridization region (e.g., indicated with dashed circles) indicates where the TE_{1A} mode in WG-A begins converting to the TE_{0B} mode in WG-B. The hybridization perturbation Δn=0.0444, 0.0297, and 0.02 at g=200 nm, 300 nm, and 400 nm, respectively. Accordingly, relatively smaller gaps may result in increased hybridization strength and more efficient mode conversion, thereby reducing mode conversion length.

In some implementations, at a wavelength of 1550 nm, the hybridization between TE_{1A} and TE_{0B} modes may be stronger relative to the hybridization at 1310 nm. Additionally, at a wavelength of 1550 nm, a large perturbation of Δn=0.0675, 0.0522, and 0.0403 at g=200 nm, 300 nm, and 400 nm, respectively, may result in a relatively stronger coupling between the TE_{1A} and TE_{0B} modes. For example, as the gap increases, the coupling between the modes may weaken, as shown by the reduced Δn. However, even at wider gaps, the conversion remains sufficiently strong with increased efficiency.

In some implementations, at a wavelength of 1580 nm, there is a relative strength increase associated with a coupling between TE_{1A} and TE_{0B} modes. For example, a perturbation associated with Δn=0.07, 0.0548, and 0.0412 at g=200 nm, 300 nm, and 400 nm, respectively, indicate efficient mode conversion. In some implementations, at larger gaps, the coupling may be associated with a relatively weaker strength, but such a design continues to enable efficient hybridization at relatively wider gaps.

In some implementations, at wavelengths of 1310 nm, 1550 nm, and/or 1580 nm, the TE_{0A} mode may pass the splitting segment without a coupling or conversion due to the large index difference compared to other modes.

As indicated above, FIGS. 9A-9B are provided as an example. Other examples may differ from what is described with regard to FIGS. 9A-9B.

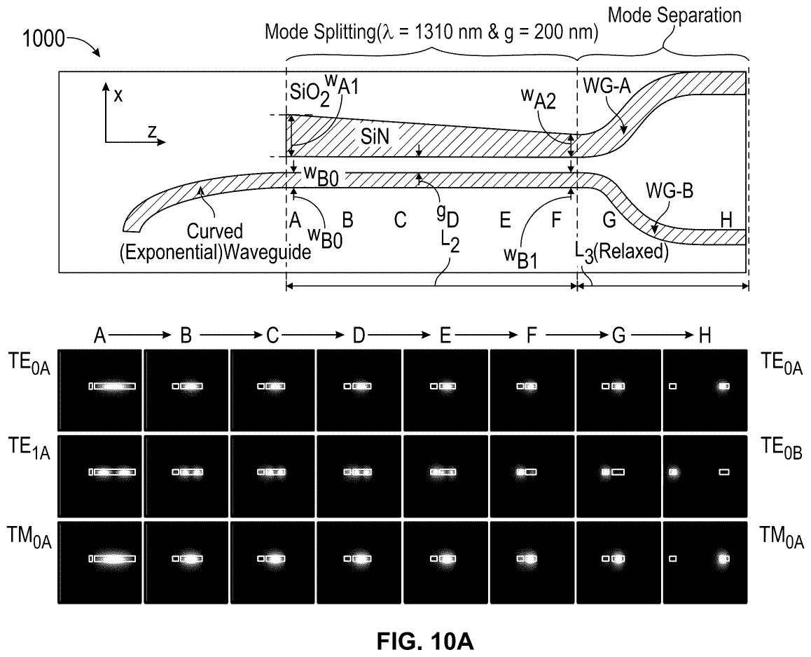

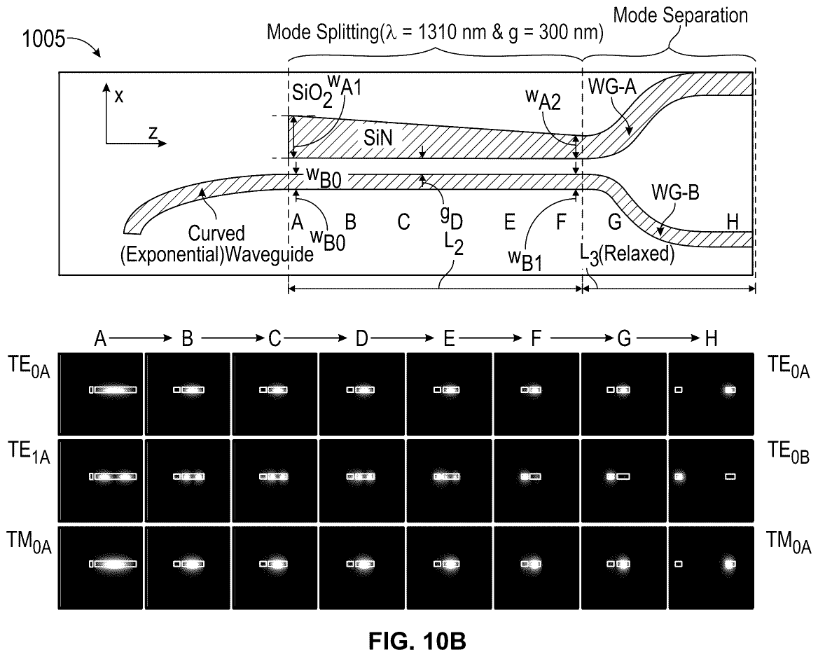

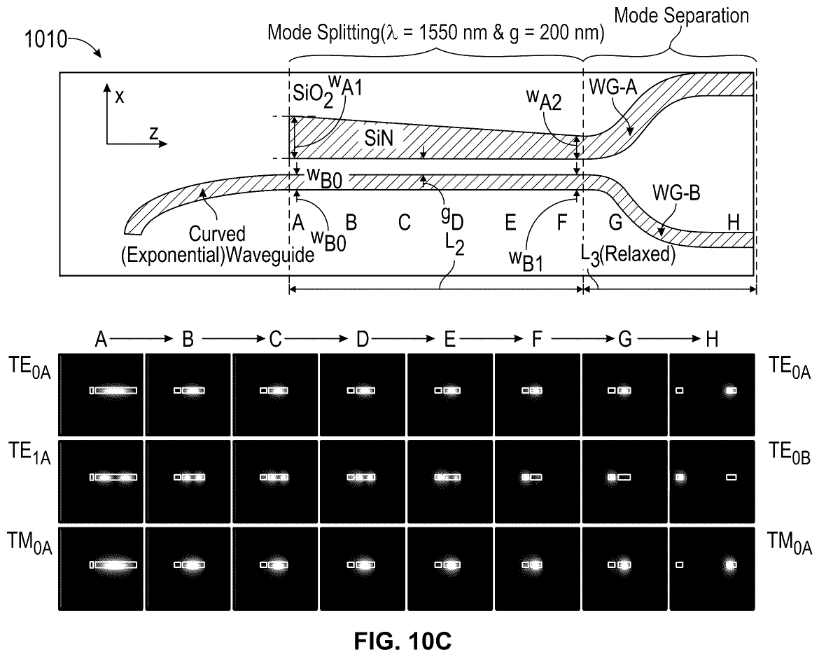

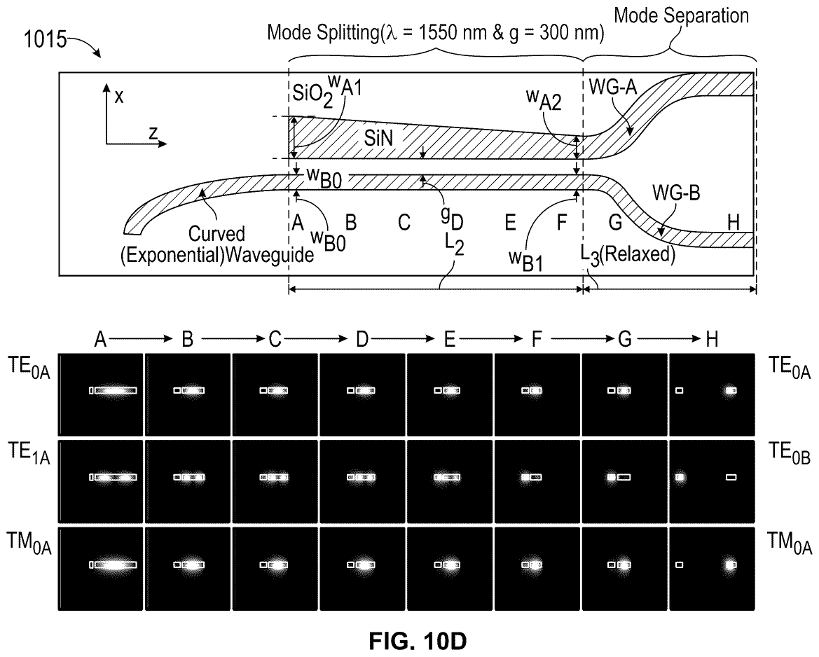

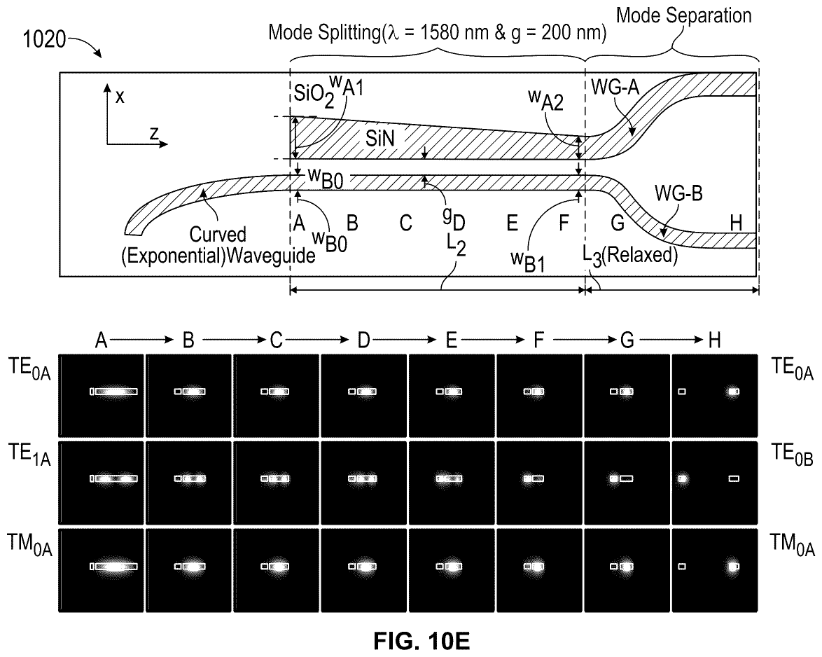

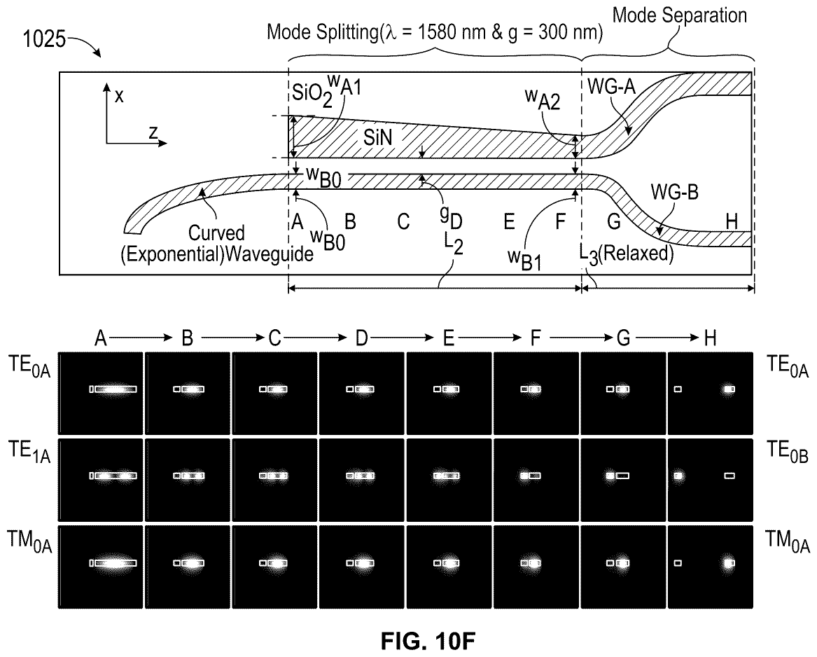

FIGS. 10A-10F illustrate examples 1000, 1005, 1010, 1015, 1020, and 1025 of field profiles of different modes for an integrated PSR.

As shown in FIG. 10A, example 1000 illustrates field profiles of different modes along a splitting length at λ=1310 nm and g=200 nm, where locations A through H denote the locations of modes along the splitting segment.

As shown in FIG. 10B, example 1005 illustrates field profiles of different modes along a splitting length at λ=1310 nm and g=300 nm, where locations A through H denote the locations of modes along the splitting segment.

As shown in FIG. 10C, example 1010 illustrates field profiles of different modes along a splitting length at λ=1550 nm and g=200 nm, where locations A through H denote the locations of modes along the splitting segment.

As shown in FIG. 10D, example 1015 illustrates field profiles of different modes along a splitting length at λ=1550 nm and g=300 nm, where locations A through H denote the locations of modes along the splitting segment.

As shown in FIG. 10E, example 1020 illustrates field profiles of different modes along a splitting length at λ=1580 nm and g=200 nm, where locations A through H denote the locations of modes along the splitting segment.

As shown in FIG. 10F, example 1025 illustrates field profiles of different modes along a splitting length at λ=1580 nm and g=300 nm, where locations A through H denote the locations of modes along the splitting segment.

FIGS. 10A-10F illustrate mode field distributions along respective mode-splitting segments of the PSR for different wavelengths and gap sizes between WG-A and WG-B. For example, FIG. 10A depicts λ=1310 nm, g=200 nm; FIG. 10B depicts λ=1310 nm, g=300 nm; FIG. 10C depicts λ=1550 nm, g=200 nm; FIG. 10D depicts λ=1550 nm, g=300 nm; FIG. 10E depicts λ=1580 nm, g=200 nm; and FIG. 10F depicts λ=1580 nm, g=300 nm. FIGS. 10A-10F depict interactions between a TE_{1A} mode associated with WG-A and a TE_{0B} mode associated with WG-B, which may be associated with increased efficiency for mode conversion and splitting.

In some implementations, relatively longer wavelengths (e.g., 1550 nm and/or 1580 nm) may be associated with increased coupling strength and increased efficiency associated with mode conversion due to enhanced hybridization perturbation Δn (e.g., as depicted in FIG. 10E), for example, in relatively smaller gaps (e.g., 200 nm). In some implementations, relatively shorter wavelengths (e.g., 1310 nm) may be associated with relatively weaker coupling and relatively smaller perturbation Δn, thereby resulting in a relatively large conversion length. Additionally, the relatively smaller gap (e.g., 200 nm) may result in increased interaction between TE_{1A} and TE_{0B}, thereby leading to relatively faster mode conversion. Additionally, relatively larger gaps may reduce coupling efficiency; although longer wavelengths may still be associated with suitable performance. In some implementations, throughout the splitting segment, the TE_{0A} mode may remain in WG-A, and the TE_{1A} mode may efficiently convert to TE_{0B} in WG-B (e.g., at longer wavelengths and smaller gaps).

As indicated above, FIGS. 10A-10F are provided as an example. Other examples may differ from what is described with regard to FIGS. 10A-10F.

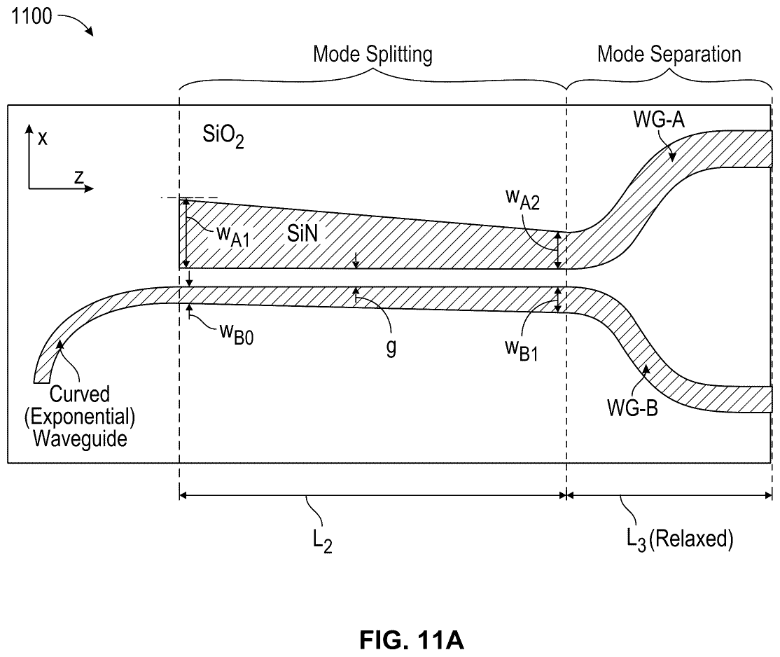

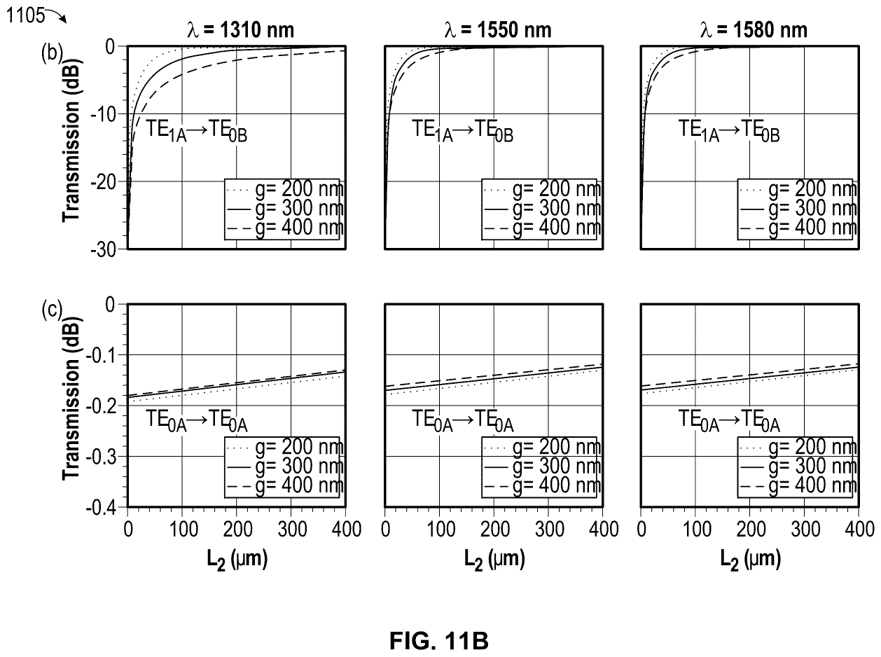

FIGS. 11A-11B illustrate example 1100 of a splitting segment and example 1105 of transmission profiles of different modes along different splitting lengths for an integrated PSR.

As shown in FIG. 11A, and by reference number 1100, a splitting segment may include a mode splitting segment and a mode separate segment. As shown in FIG. 11B, mode conversion lengths are depicted along the splitting length, L₂ at λ=1310 nm, λ=1550 nm, and λ=1580 nm, and at different gaps (e.g., g) of 200 nm, 300 nm, and 400 nm between WG-A and WG-B. In some implementations, a TE_{1A} mode in WG-A may convert into a TE0B mode in WG-B, while a TE0A mode may remain in WG-A.

As shown in FIG. 11B, and by reference number 1105, in some implementations, the transmission profiles for the TE_{1A} mode at different wavelengths (e.g., 1310 nm, 1550 nm, and 1580 nm) and gap sizes depict changes in mode coupling efficiency according to wavelength and gap. At a wavelength of 1310 nm, the mode coupling efficiency is lower relative to longer wavelengths, including for relatively larger gaps. The 200 nm curve depicts the highest level of coupling strength, indicating that smaller gaps may allow for increased efficiency associated with mode conversion for a relatively short splitting length. At a wavelength of 1550 nm, the coupling between TE_{1A} and TE_{0B} may be associated with a higher level of strength than at a wavelength of 1310 nm, relative to the transmission profiles for the remaining gap sizes. In some implementations, the gap size may affect the coupling, but the overall efficiency remains relatively higher at a wavelength of 1550 nm. At a wavelength of 1580 nm, the mode coupling may be associated with a higher strength level relative to the strength level at a wavelength of 1550 nm. In some implementations, for relatively larger gaps (e.g., g=300 nm), the transmission profiles indicate a relatively short conversion length from TE_{1A} to TE_{0B}. The g=200 nm case is associated with the relatively lowest conversion length, but the g=300 nm and g=400 nm cases may be associated with increased performance at a 1580 nm wavelength. Accordingly, a mode conversion length (e.g. for a wavelength of 1310 nm) may be utilized that is sufficient for different wavelength ranges, where different wavelengths may be associated with relatively small conversion lengths.

In some implementations, the transmission profiles for a TE_{0A} mode may remain unaffected across wavelengths and gap sizes. The transmission profiles associated with the TE_{0A} mode demonstrate consistent performance, thereby enabling relatively minimal interaction or interference with other modes due to significant index contrast. For each wavelength, regardless of gap size, the TE_{0A} mode in WG-A maintains a respective path with no substantial losses or coupling to WG-B. As a result, according to some examples described herein, for the sets of parameters for the waveguide cross-sections, the respective gaps between waveguides, and the length of the mode splitter, a PSR may be associated with improved performance in the O-band, the C-band, and/or the L-band. For example, the described parameters may include only SiN waveguides that are compatible with a PSR and are associated with improved broadband performance.

As indicated above, FIGS. 11A-11B are provided as an example. Other examples may differ from what is described with regard to FIGS. 11A-11B.

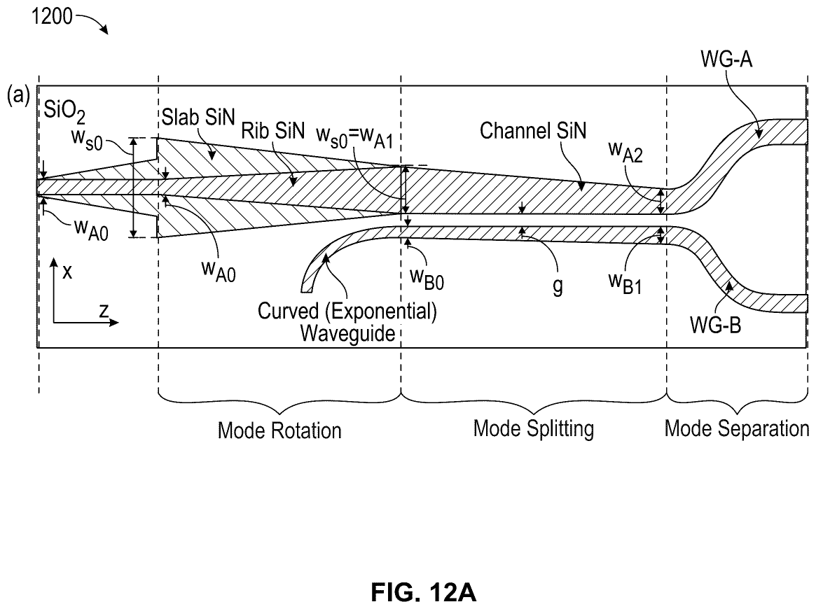

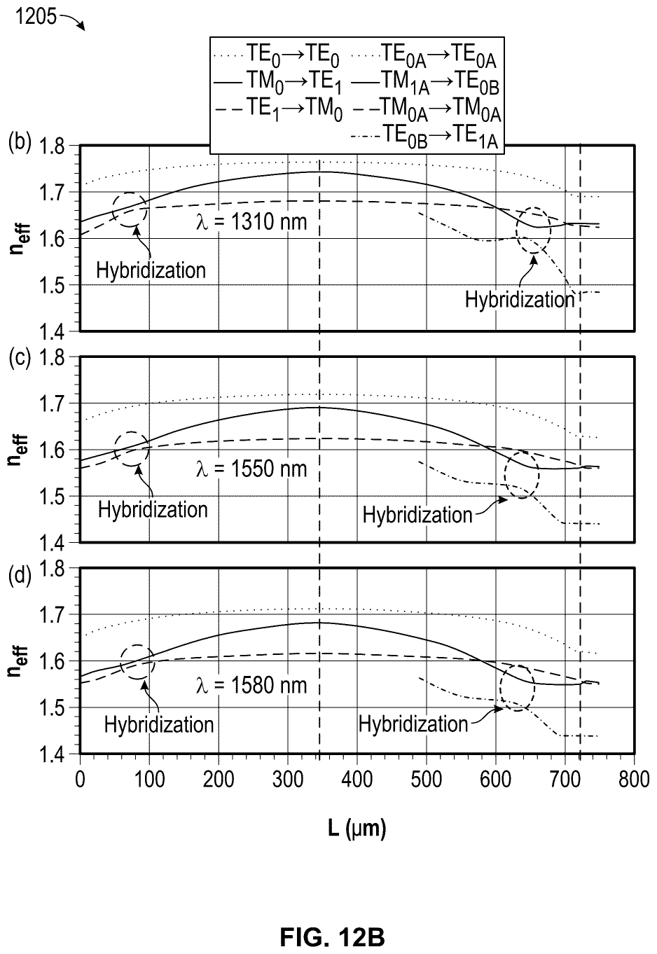

FIGS. 12A-12B illustrate example 1200 of a schematic of integrated PSR and example 1205 of effective indices (e.g., n_{eff}) for an integrated PSR.

As shown in FIG. 12A, a PSR may include a mode rotation segment, splitting segment, and separation segment. In some implementations, a rib SiNₓ waveguide may be tapered as w_{A0} to w_{A1}, and slab SiNₓ waveguides may be tapered as wₛ₀ to wₛ₁ in the mode rotation segment. In some implementations, in the splitting segment, channel SiNₓ WG-A and WG-B may be tapered as w_{A1} to w_{A2} and w_{B0} to w_{B1}, respectively. In some implementations, SiO2 may be utilized as top and bottom cladding. Additionally, for example, h_{SiN}=400 nm, h_{S}=200 nm, w_{A0}=1000 nm, w_{A1}=4000 nm, w_{A2}=1000 nm, w_{S0}=6000, w_{S1}=4000 nm, w_{B0}=300 nm, and w_{B1}=700 nm.

As shown in FIG. 12B, and by reference number 1205, effective indices (e.g., n_{eff}) along the PSR length are depicted for wavelengths of 1310 nm, 1550 nm, and 1580 nm. In some implementations, the effective index of the TE₀ mode may increase in association with the rib SiNₓ widths in the mode rotation segment, and the effective index of the TE₀ mode may decrease with channel SiNₓ widths in the splitting segment. The TE₀ may output as a TE₀ mode in WG-A without any coupling or conversion due to a large index contrast with other modes. Additionally, or alternatively, in the rotation segment, the TM₀ mode may first couple with and hybridize with a TE₁ mode (e.g., mode rotation) and then couple with and hybridize with the TE₀ mode (e.g., splitting and coupling) and output at WG-B as a TE₀ mode. For example, hybridization regions are indicated with red dashed circles, indicating occurrences of mode coupling and conversion. These hybridization regions may be utilized in the functioning of the PSR, and may enable conversion associated with TM0→TE_{1A}→TE_{0B}.

Some implementations described herein relate to a PSR. Some implementations described herein relate to a waveguide device for rotation and/or splitting. The waveguide device may include an optical cladding and a SiNₓ waveguide core. In some implementations, the PSR may include a rotator configured to transmit light. The rotator may include an optical cladding including a top optical cladding and a bottom optical cladding, and a SiNₓ waveguide core surrounded by the optical cladding and having an upper layer and a lower layer. In some implementations, the upper layer may have a first upper width and a second upper width, and the first upper width may decreasingly taper to the second upper width across a length of the SiNₓ waveguide core. Additionally, the lower layer may have a first lower width and a second lower width, and the first lower width may increasingly taper to the second lower width across the length of the SiNₓ waveguide core, and the second upper width may be greater than or equal to the second lower width. In some implementations, the top optical cladding and the bottom optical cladding may be silicon dioxide (SiO₂) cladding.

Furthermore, in some implementations, the rotator may be configured to operate in an an O-band wavelength, a C-band wavelength, and an L-band wavelength. In some implementations, the SiNₓ waveguide core may include a slab SiNₓ waveguide and a rib SiNₓ waveguide. In some implementations, the slab SiNₓ waveguide may have a width of greater than approximately 1000 nm. Additionally, in some implementations, the slab SiNₓ waveguide may have a plurality of widths along a length, where each width, of the plurality of widths, is between approximately 200 nm and approximately 4000 nm. Furthermore, the slab SiNₓ waveguide may have a height between approximately 100 nm and approximately 300 nm.

In some implementations, the PSR may include a mode splitter configured to transmit light, the mode splitter being optically connected to the rotator. The mode splitter may include a mode splitter segment having a first end and a second end, and the mode splitter segment may include a first waveguide and a second waveguide. In some implementations, the first waveguide may have a first width corresponding to the first end of the mode splitter segment and a second width corresponding to the second end of the mode splitter segment, the first width being greater than or equal to the second width. In some implementations, the second waveguide may have a first width corresponding to the first end of the mode splitter segment and a second width corresponding to the second end of the mode splitter segment, the first width being less than or equal to the second width.

In some implementations, the waveguide device may have an optical cladding and a SiNₓ waveguide core. In some implementations, the waveguide device may include a core having a lower layer and an upper layer, a first device region where the upper layer overlays a subset of an area associated with the lower layer, and a second device region where the area associated with the upper layer is equal to the area associated with the lower layer. In some implementations, the waveguide device may be integrated with a PIC.

In some implementations, the waveguide device may be formed using slab and rib SiNₓ waveguides. In some implementations the slab SiNₓ waveguide may have a width greater than or equal to approximately 1000 nm, thereby improving the efficacy of mode confinement and coupling. In some implementations, the rib SiNₓ waveguide may have a width within a range of approximately 200 nm to approximately 4000 nm, inclusive. In some implementations, the slab SiNₓ waveguide may have a height within a range of approximately 100 nm to approximately 300 nm, inclusive.

In some implementations, the PSR may be optically connected to a mode splitter. In some implementations, the mode splitter (e.g., a mode splitter segment) may include two waveguides. In some implementations, the two waveguides may be tapered in a mode splitter segment (e.g., having a length of L₂), thereby enabling increased efficiency associated with broadband mode conversion between a TE₁ mode and a TE₀ mode. In some implementations, the rib SiNₓ waveguide may have a height of approximately 400 nm. Additionally, or alternatively, in some implementations, the slab SiNₓ waveguide may have a height of approximately 400 nm. As a result, splitting in the PSR may be improved.

Additionally, in some implementations, the PSR may be associated with air or a low-index material cladding, among other examples.

As indicated above, FIGS. 12A-12B are provided as an example. Other examples may differ from what is described with regard to FIGS. 12A-12B.

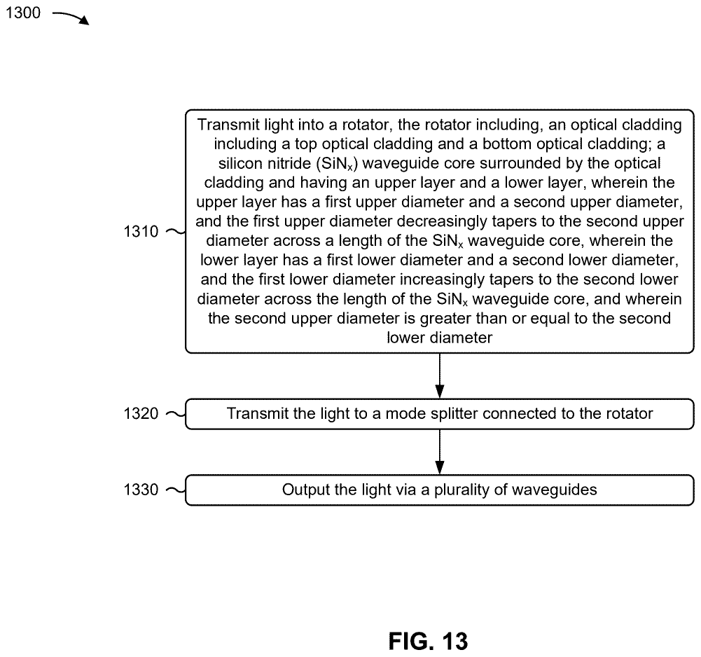

FIG. 13 is a flowchart of an example process 1300 associated with an integrated PSR. One or more process blocks of FIG. 13 are performed by an optical assembly and/or by another device or a group of devices separate from or including the optical assembly, such as a rotator and/or a mode splitter, as described herein. Additionally, or alternatively, one or more process blocks of FIG. 13 may be performed by one or more components of the optical assembly, the rotator, and/or the mode splitter, as described herein.

As shown in FIG. 13, process 1300 includes transmitting light into a rotator, the rotator including: an optical cladding including a top optical cladding and a bottom optical cladding; a silicon nitride (SiNₓ) waveguide core surrounded by the optical cladding and having an upper layer and a lower layer, where the upper layer has a first upper width and a second upper width, and the first upper width decreasingly tapers to the second upper width across a length of the SiNₓ waveguide core, where the lower layer has a first lower width and a second lower width, and the first lower width increasingly tapers to the second lower width across the length of the SiNₓ waveguide core, and where the second upper width is greater than or equal to the second lower width (block 1310). For example, the optical assembly may transmit light into a rotator, the rotator including: an optical cladding including a top optical cladding and a bottom optical cladding; a SiNₓ waveguide core surrounded by the optical cladding and having an upper layer and a lower layer, where the upper layer has a first upper width and a second upper width, and the first upper width decreasingly tapers to the second upper width across a length of the SiNₓ waveguide core, where the lower layer has a first lower width and a second lower width, and the first lower width increasingly tapers to the second lower width across the length of the SiNₓ waveguide core, and where the second upper width is greater than or equal to the second lower width, as described above.

As further shown in FIG. 13, process 1300 includes transmitting the light, from the rotator, to a mode splitter connected to the rotator (block 1320). For example, the optical assembly may transmit the light, from the rotator, to a mode splitter connected to the rotator, as described above.

As further shown in FIG. 13, process 1300 includes outputting the light, from the mode splitter, via a plurality of waveguides (block 1330). For example, the optical assembly may output the light, from the mode splitter, via a plurality of waveguides, as described above.

Process 1300 may include additional aspects, such as any single aspect or any combination of aspects described below and/or in connection with one or more other processes described elsewhere herein.

In a first aspect, the mode splitter is associated with a mode splitter segment having a first end and a second end, and where the mode splitter segment includes a first waveguide and a second waveguide, of the plurality of waveguides.

In a second aspect, alone or in combination with the first aspect, the SiNₓ waveguide core includes a slab SiNₓ waveguide and a rib SiNₓ waveguide.

Although FIG. 13 shows example blocks of process 1300, in some implementations, process 1300 includes additional blocks, fewer blocks, different blocks, or differently arranged blocks than those depicted in FIG. 13. Additionally, or alternatively, two or more of the blocks of process 1300 may be performed in parallel.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

As used herein, the term “component” is intended to be broadly construed as hardware, firmware, and/or a combination of hardware and software.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When a component or one or more components (e.g., a laser emitter or one or more laser emitters) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). Further, spatially relative terms, such as “below,” “lower,” “above,” “upper,” and the like, may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

What is claimed is:

1. A rotator, comprising:
an optical cladding including a top optical cladding and a bottom optical cladding; and
a silicon nitride (SiNₓ) waveguide core surrounded by the optical cladding and having an upper layer and a lower layer,
wherein the upper layer has a first upper width and a second upper width, and the first upper width decreasingly tapers to the second upper width across a length of the SiNₓ waveguide core,
wherein the lower layer has a first lower width and a second lower width, and the first lower width increasingly tapers to the second lower width across the length of the SiNₓ waveguide core, and
wherein the second upper width is greater than or equal to the second lower width.

2. The rotator of claim 1, wherein the top optical cladding and the bottom optical cladding are silicon dioxide (SiO₂) cladding.

3. The rotator of claim 1, wherein the top optical cladding is air.

4. The rotator of claim 1, wherein the rotator is optically connected to a mode splitter.

5. The rotator of claim 4, wherein the mode splitter is associated with a mode splitter segment having a first end and a second end, and wherein the mode splitter segment includes a first waveguide and a second waveguide.

6. The rotator of claim 5, wherein the first waveguide has a first width corresponding to the first end of the mode splitter segment and a second width corresponding to the second end of the mode splitter segment, the first width being greater than the second width.

7. The rotator of claim 5, wherein the first waveguide has a first width corresponding to the first end of the mode splitter segment and a second width corresponding to the second end of the mode splitter segment, the first width being equal to the second width.

8. The rotator of claim 5, wherein the second waveguide has a first width corresponding to the first end of the mode splitter segment and a second width corresponding to the second end of the mode splitter segment, the first width being less than the second width.

9. The rotator of claim 5, wherein the second waveguide has a first width corresponding to the first end of the mode splitter segment and a second width corresponding to the second end of the mode splitter segment, the first width being equal to the second width.

10. The rotator of claim 1, wherein the rotator is configured to operate in an O-band wavelength, a C-band wavelength, and an L-band wavelength.

11. The rotator of claim 1, wherein the SiNₓ waveguide core includes a slab SiNₓ waveguide and a rib SiNₓ waveguide.

12. The rotator of claim 11, wherein the slab SiNₓ waveguide has a width of greater than approximately 1000 nanometers.

13. The rotator of claim 11, wherein the slab SiNₓ waveguide has a plurality of widths along a length, wherein each width, of the plurality of widths, is between approximately 200 nanometers and approximately 4000 nanometers.

14. The rotator of claim 11, wherein the slab SiNₓ waveguide has a height between approximately 100 nanometers and approximately 300 nanometers.

15. A method, comprising:
transmitting light into a rotator, the rotator including:
an optical cladding including a top optical cladding and a bottom optical cladding;
a silicon nitride (SiNₓ) waveguide core surrounded by the optical cladding and having an upper layer and a lower layer,
wherein the upper layer has a first upper width and a second upper width, and the first upper width decreasingly tapers to the second upper width across a length of the SiNₓ waveguide core,
wherein the lower layer has a first lower width and a second lower width, and the first lower width increasingly tapers to the second lower width across the length of the SiNₓ waveguide core, and
wherein the second upper width is greater than or equal to the second lower width;
transmitting the light, from the rotator, to a mode splitter connected to the rotator; and
outputting the light, from the mode splitter, via a plurality of waveguides.

16. The method of claim 15, wherein the mode splitter is associated with a mode splitter segment having a first end and a second end, and wherein the mode splitter segment includes a first waveguide and a second waveguide, of the plurality of waveguides.

17. The method of claim 15, wherein the SiNₓ waveguide core includes a slab SiNₓ waveguide and a rib SiNₓ waveguide.

18. An optical assembly, comprising:
a rotator configured to transmit light, the rotator including:
an optical cladding including a top optical cladding and a bottom optical cladding, and
a silicon nitride (SiNₓ) waveguide core surrounded by the optical cladding and having an upper layer and a lower layer,
wherein the upper layer has a first upper width and a second upper width, and the first upper width decreasingly tapers to the second upper width across a length of the SiNₓ waveguide core,
wherein the lower layer has a first lower width and a second lower width, and the first lower width increasingly tapers to the second lower width across the length of the SiNₓ waveguide core, and
wherein the second upper width is greater than or equal to the second lower width; and
a mode splitter configured to transmit the light, the mode splitter optically connected to the rotator,
wherein the mode splitter is associated with a mode splitter segment having a first end and a second end, and wherein the mode splitter segment includes a first waveguide and a second waveguide, and
wherein the first waveguide has a first width corresponding to the first end of the mode splitter segment and a second width corresponding to the second end of the mode splitter segment, the first width being greater than or equal to the second width.

19. The optical assembly of claim 18, wherein the rotator is configured to operate in an O-band wavelength, a C-band wavelength, and an L-band wavelength.

20. The optical assembly of claim 18, wherein the top optical cladding and the bottom optical cladding are silicon dioxide (SiO₂) cladding.
